(19) United States
(12) Patent Application Publication
(10) Pub. No.: US 2018/0128909 A1
(43) Pub. Date: May 10, 2018

(54) METHOD FOR OBTAINING HORIZONTAL LONGITUDINAL CORRELATION OF DEEP-SEA GREAT-DEPTH SOUND FIELD

(71) Applicant: Northwestern Polytechnical University, Xi'an (CN)

(72) Inventors: Kunde YANG, Xi'an (CN); Hui LI, Xi'an (CN); Rui DUAN, Xi'an (CN); Zhengyao HE, Xi'an (CN); Shunli DUAN, Xi'an (CN); Bo LEI, Xi'an (CN); Yina HAN, Xi'an (CN)

(21) Appl. No.: 15/806,921

(22) Filed: Nov. 8, 2017

(30) Foreign Application Priority Data
Nov. 10, 2016 (CN) 201610986623.X

(51) Int. Cl. G01S 11/14

(52) U.S. Cl. CPC G01S 11/14

(57) ABSTRACT

The present invention relates to a method for obtaining horizontal longitudinal correlation of a deep-sea great-depth sound field. Two testing positions with the same depth and different distances are selected near a deep-sea bottom; time delay differences between a direct wave of a deep sound source in a certain depth reaching two receiving positions and a surface-reflected wave are calculated according to a ray model; one testing position is fixed, and a horizontal spacing between the two positions is continuously changed to recalculate the time delay differences in different positions; and the time delay differences are substituted into a ray theory-based calculation formula of horizontal longitudinal correlation of the deep-sea great-depth sound field to obtain a change rule of the horizontal longitudinal correlation of a target region. The present invention greatly reduces amount of calculation, and is easy in engineering practice.

### TECHNICAL FIELD

The present invention belongs to processing methods of underwater sound signals, relates to a method for obtaining horizontal longitudinal correlation of a deep-sea great-depth sound field, is applicable to qualitative analysis of the horizontal longitudinal correlation of the deep-sea great-depth sound field and quantitative estimate of a correlation length, and belongs to the fields of ocean engineering, underwater acoustic engineering, array signal processing, sonar technologies, etc.

### BACKGROUND OF THE INVENTION

Target detection, positioning, tracking and identification in a background of ocean channels are of great significance to the fields of underwater information warfare, ocean engineering and the like. The development of processing of underwater sound signals is roughly divided into two phases:

(1) In the first phase, an ocean channel is assumed as an ideal communication channel to actively develop an adaptive array signal processing technology for enhancing array signal processing gains.

(2) In the second phase, people find that an array signal processing technology in an actual ocean background cannot reach ideal performance and gradually recognize complexity of the ocean channel. A matched-field processing technology, a waveguide invariant-based processing technology and the like emerge as the times demand.

A single hydrophone target positioning technology based on a modal dispersion effect, a waveguide invariant theory, a sound ray multipurpose feature, a sound field interference period and the like is rapidly developed. However, a target positioning method based on the single hydrophone often needs higher signal-to-noise ratio conditions, and is difficult to satisfy actual needs. Meanwhile, with the development of a vibration damping and noise reduction technology of a submarine, a noise level of a novel quiet submarine is close to or even lower than an ocean noise level, thereby proposing new requirements for processing of the underwater sound signals. Therefore, a difficult problem to be urgently solved at present is to study a new target detection and identification technology based on underwater sound physics and array signal processing with respect to underwater weak target signals.

In practice ocean application, common arrays include a vertical linear array and a horizontal linear array. According to the difference in anchoring modes, the vertical linear array includes two arrangement forms: buoy and submerged buoy. The horizontal linear array generally includes a sea-bottom horizontal linear array and a towed horizontal linear array. As a national strategic objective of “deepening offshore and shallow sea and extending deep sea” is proposed, a target passive detection technology under reliable sound path propagation conditions is further developed. Meanwhile, it is possible to arrange the horizontal linear array at the sea bottom under assistance of an autonomous vehicle. However, a current array design method still continues a design idea oriented by array signal processing; an absolute length of the array is generally in direct proportion to the wavelength corresponding to a lowest frequency for operation of the array; the effect of underwater sound propagation characteristics on signal correlation is not fully considered; and a design suitable for arranging the horizontal linear array at a deep sea bottom lacks of theoretical guidance.

In addition, regardless of receiving arrays arranged near the sea bottom in any form, when a moving target near the sea surface is detected, signals in signal integration time are required to be in strong correlation. Technical bottlenecks that the signal integration time is not fully applied in current sonar technology are as follows: the first bottleneck is that the moving target may cross multiple beam main lobe widths due to too long integration time; and the other reason is the limitation of a correlation length of signals. According to reciprocity of the sound field, a detection problem of the moving target near the sea surface and a design problem of the horizontal array in submarine anchoring can be summarized into calculation problems of correlation of the sound field near the sea bottom.

An existing method for solving the above problems is to simulate a change rule of the correlation of the sound field online through underwater sound modeling in combination with a normal mode theory or a ray theory, etc. according to measured ocean environment parameters. The method consumes a large number of calculation time, and is limited to environmental complexity, and a calculation result cannot be transferred to other ocean backgrounds. Moreover, the calculation result cannot reflect how the underwater sound propagation affects the signal correlation. At present, a simple and intuitive calculation method having practice physical significance is absent. The present invention aims to propose an accurate and simple correlation calculating method, so as to provide reference convenience for engineering application.

### SUMMARY OF THE INVENTION

The present invention proposes a method for obtaining horizontal longitudinal correlation of a deep-sea great-depth sound field to avoid defects of the prior art, and the method is applicable to calculation of the correlation length of the sound field during deep-sea great-depth reception.

A method for obtaining horizontal longitudinal correlation of a deep-sea great-depth sound field comprises the following steps:

step 1: determining two receiving positions with the same depth and different distances from the deep sound source near a deep-sea bottom as testing positions, wherein coordinates of the two receiving positions are respectively (z,r) and (z,r+Δr); z indicates a receiving depth; r indicates a receiving distance; Δr indicates a horizontal longitudinal spacing of the two receiving positions; the depth of a wideband deep sound source is indicated by z; and a center frequency is indicated by ω₀;

step 2: calculating a time delay difference Δtᵣ between a direct wave of a wideband deep sound source reaching the receiving position (z,r) and a surface-reflected wave according to a ray model Bellhop, and calculating a time delay difference Δt_{r+Δr} between a direct wave of the wideband deep sound source reaching the receiving position (z,r+Δr) and the surface-reflected wave according to the ray model Bellhop; and

step 3: substituting the time delay differences Δtᵣ and Δt_{r+Δr} into a calculation formula of horizontal longitudinal correlation of the sound field.

$$p ( r , r + Δ r ) = cos ( \frac{{ω}_{0}}{2} ( Δ {t}_{r} - Δ {t}_{r} + {Δ}_{r} ) )$$

to obtain a horizontal longitudinal correlation coefficient of the sound field between two different receiving distances r and r+Δr when the depth of the sound source is zₛ and the receiving depth is z.

One testing position is fixed; the distance of the other testing position is changed along a horizontal direction, so that the horizontal longitudinal spacing Δr of the two receiving positions is changed; and then step 2 and step 3 are repeated to obtain a change rule of the correlation of the sound field along with the horizontal longitudinal spacing when a reference receiving distance is r.

The reference receiving distance r is changed, and then step 2 and step 3 are repeated to obtain the change rule of the correlation of the sound field at different receiving distances.

A change range of the sound source depth of the wideband deep sound source is 10-1000 m.

A frequency range of the wideband deep sound source is 10 Hz-5 kHz.

A receiving distance from the deep sound source to the receiving position is 0-30 km, and the receiving depth is in a range of 1000-10000 m.

In the method for obtaining the horizontal longitudinal correlation of the deep-sea great-depth sound field proposed by the present invention, two testing positions with the same depth and different distances are selected near a deep-sea bottom; time delay differences between a direct wave and a sea surface wave from a sound source in a certain depth to two receiving positions are calculated according to a ray model; one testing position is fixed; a horizontal spacing between the two positions is continuously changed to recalculate the time delay differences between the direct wave and the surface-reflected wave in different positions; and the time delay differences are substituted into a ray theory-based calculation formula of horizontal longitudinal correlation of the deep-sea great-depth sound field to obtain a change rule of the horizontal longitudinal correlation of a target region.

The present invention has the beneficial effects that:

(1) The qualitative change rule of the correlation of the sound field can be described according to the formula.

(2) Compared with a method of estimating a correlation length of the sound field online through complicated sound field modeling, the method greatly reduces amount of calculation, and is easy in engineering practice.

### DESCRIPTION OF THE DRAWINGS

FIG. 1 shows a sound velocity profile used in simulation.

FIG. 2 shows an arrival structure of a direct wave and a surface-reflected wave obtained by a ray model.

FIG. 3 shows a distribution diagram of arrival time delay differences of a direct wave and a surface-reflected wave (receive depth of 4700 m).

FIG. 4 shows a theoretical calculation result of a correlation coefficient (center frequency of 310 Hz; receiving depth of 4700 m).

(a) sound source depth of 50 m; (b) sound source depth of 100 m; (c) sound source depth of 150 m; (d) sound source depth of 200 m.

FIG. 5 shows a modeling calculation result of a correlation coefficient (sound source frequency of 260-360 Hz; receiving depth of 4700 m).

(a) sound source depth of 50 m; (b) sound source depth of 100 m; (c) sound source depth of 150 m; (d) sound source depth of 200 m.

FIG. 6 shows a comparison result of theoretical and modeling calculations of correlation lengths at different sound source depths (sound source frequency of 260-360 Hz; receiving depth of 4700 m).

(a) sound source depth of 50 m; (b) sound source depth of 100 m; (c) sound source depth of 150 m; (d) sound source depth of 200 n.

### DETAILED DESCRIPTION OF THE INVENTION

The present invention is further described in combination with embodiments and drawings.

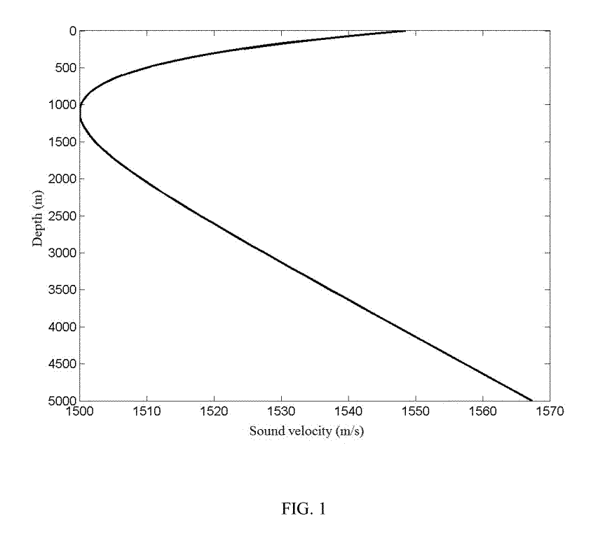

FIG. 1 shows a sound velocity profile used in simulation.

A typical deep-sea Munk profile is adopted for calculating arrival time delay differences of a direct wave and a surface-reflected wave of a sound ray, and a sound velocity is shown in FIG. 1. Because the sound field in a deep-sea direct wave region is mainly contributed by the direct wave and the surface-reflected wave, the effect of a sea-bottom reflected wave on calculation of the correlation is neglected.

A calculation process is divided into the following five steps:

step 1: assuming that the depth of the wideband sound source is zₛ, and the center frequency is ω₀, wherein coordinates of the two receiving positions are respectively (z,r) and (z,r+Δr); z indicates a receiving depth; r indicates a receiving distance; and Δr indicates a horizontal longitudinal spacing of the two receiving positions;

step 2: calculating a time delay difference Δtᵣ between a direct wave of a wideband deep sound source reaching the receiving position (z,r) and a surface-reflected wave according to a ray model Bellhop, and calculating a time delay difference Δt_{r+Δr} between a direct wave of the wideband deep sound source reaching the receiving position (z,r+Δr) and the surface-reflected wave according to the ray model Bellhop; and

step 3: substituting the calculated time delay differences Δtᵣ and Δt_{r+Δr} into a calculation formula of horizontal longitudinal correlation of the sound field

$$p ( r , r + Δ r ) = cos ( \frac{{ω}_{0}}{2} ( Δ {t}_{r} - Δ {t}_{r} + {Δ}_{r} ) )$$

to obtain a horizontal longitudinal correlation coefficient of the sound field between two different receiving distances r and r+Δr when the depth of the sound source is zₛ and the receiving depth is z;

step 4: changing Δr to obtain a change rule of the correlation of the sound field along with the horizontal longitudinal spacing when a reference receiving distance is r; and

step 5: changing the reference receiving distance r to obtain the change rule of the correlation of the sound field at different receiving distances.

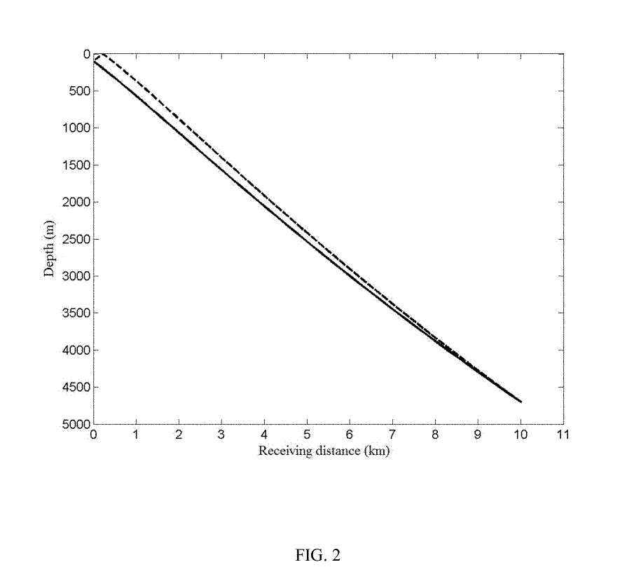

FIG. 2 shows an arrival structure of a direct wave and a surface-reflected wave obtained by a ray model.

FIG. 2 shows an arrival structure of a direct wave and a surface-reflected wave at the receiving distance of 10 km and the receiving depth of 4700 m when the sound source depth is 100 m, wherein the propagation time of the direct wave is 7.1786 s; the propagation time of the surface-reflected wave is 7.2284 s; and the time delay difference between the direct wave and the surface-reflected wave is 0.0498 s. The time delay difference between the direct wave and the surface-reflected wave is called the time delay difference for short.

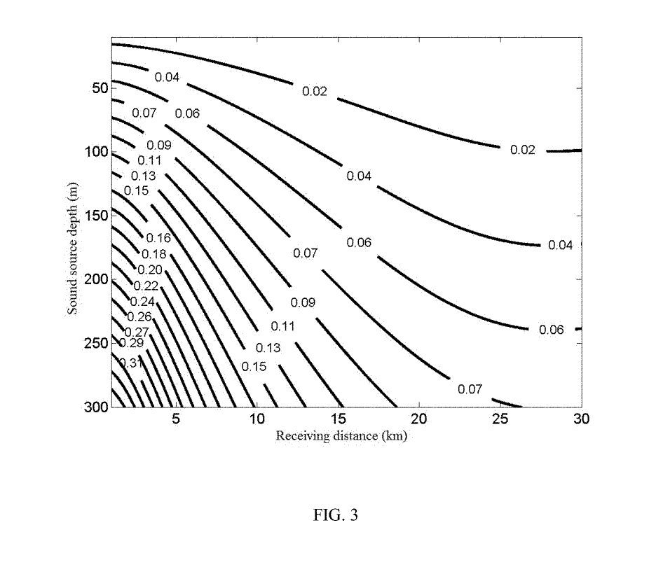

FIG. 3 shows a distribution diagram of arrival time delay differences of a direct wave and a surface-reflected wave.

FIG. 3 shows a distribution result of time delay differences at different sound source depths and different receiving distances when the receiving depth is 4700 m. It can be seen that for a fixed sound source depth, the further the receiving distance is, the slower the change of the time delay differences is; the deeper the sound source depth is, the larger the gradient of the change of the time delay differences along with the distance is. Therefore, the further the receiving distance is, the slower the change of the horizontal longitudinal correlation is, i.e., the larger the period of change is; the deeper the sound source depth is, the quicker the change of the horizontal longitudinal correlation is, i.e., the shorter the period of change is.

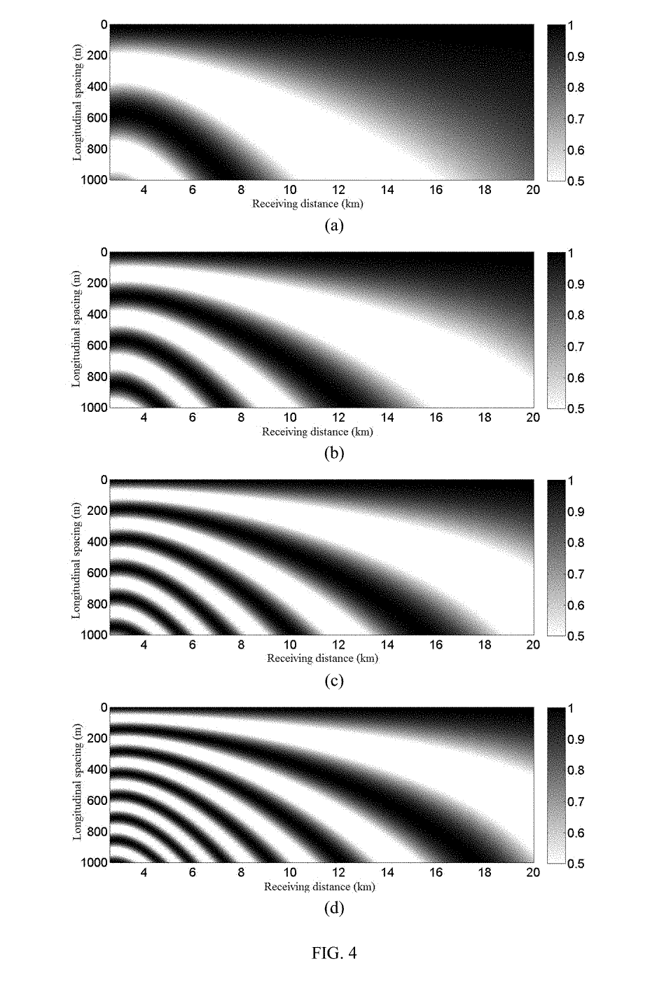

FIG. 4 shows a theoretical calculation result of a correlation coefficient.

According to the distribution diagram of time delay differences obtained in FIG. 3, the theoretical calculation result of the horizontal longitudinal correlation coefficient of the sound field is shown in FIG. 4, wherein the center frequency ω0 is 310 Hz, and the receiving depth is 4700 m. (a) Sound source depth is 50 m; (b) sound source depth is 100 m; (c) sound source depth is 150 m; and (d) sound source depth is 200 m.

A horizontal axis indicates a receiving distance r as a reference position when the correlation is calculated, and a longitudinal axis indicates a horizontal longitudinal spacing Δr relative to the reference receiving position.

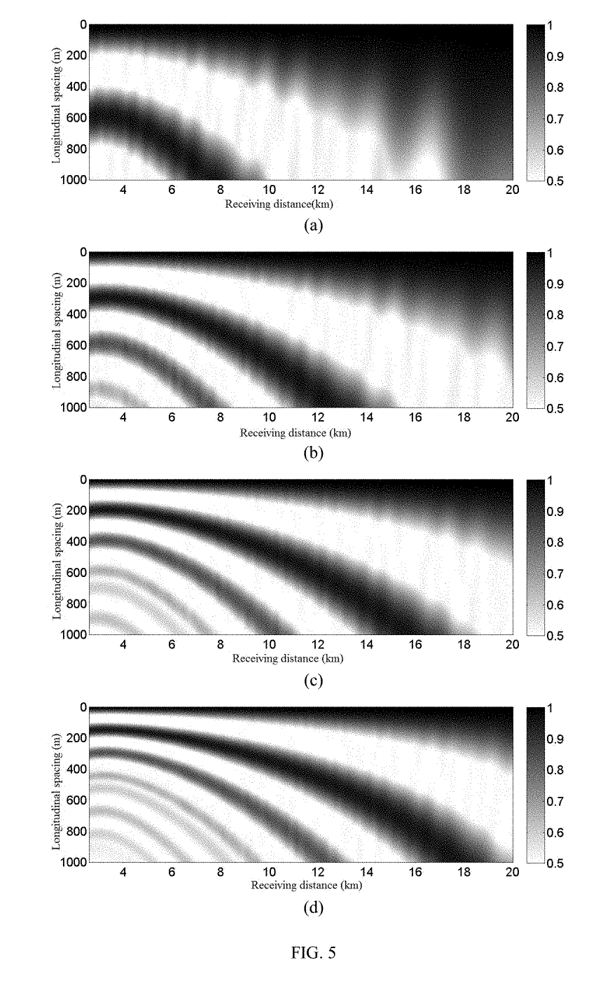

FIG. 5 shows a modeling calculation result of a correlation coefficient.

FIG. 5 gives a change result of the horizontal longitudinal correlation coefficient of the sound field obtained through numerical modeling to verify the accuracy of the theoretical calculation result. The sound source frequency is 260-360 Hz, and the receiving depth is 4700 m. (a) Sound source depth is 50 m; (b) sound source depth is 100 m; (c) sound source depth is 150 m; and (d) sound source depth is 200 m. Compared with FIG. 4, it can be seen that the change rule of the theoretical calculation result and the change rule of the numerical modeling result are consistent, and a change trend of the horizontal longitudinal correlation of the sound field is better predicted.

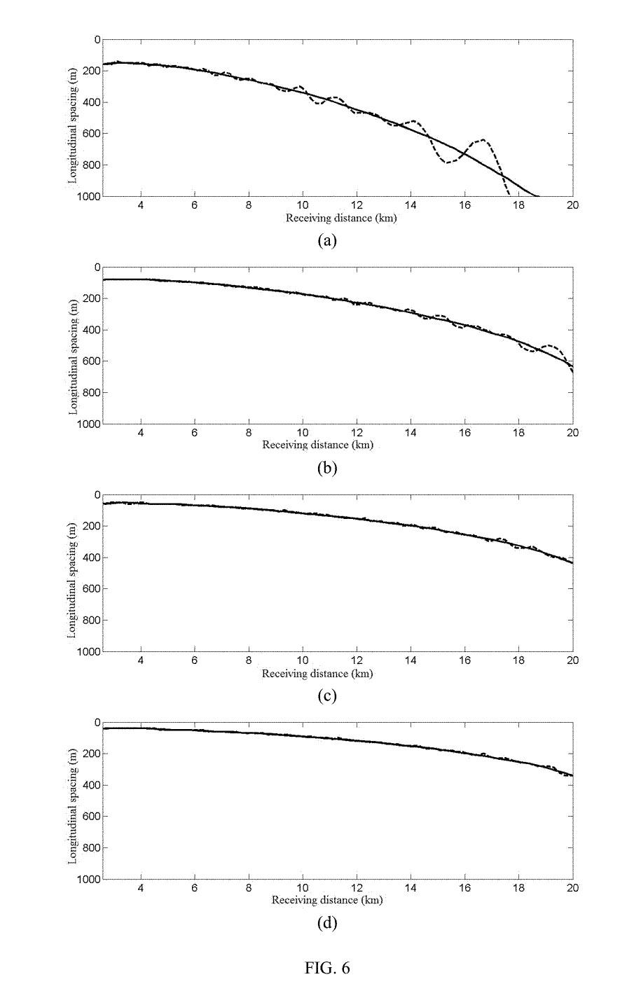

FIG. 6 shows a comparison result of theoretical and modeling calculations of correlation lengths at different sound source depths.

In practical application, a corresponding longitudinal spacing is defined as a correlation length when the correlation coefficient is decreased to 0.707. When the sound source frequency is 260-360 Hz and the receiving depth is 4700 m, a black dotted line in FIG. 6 is a correlation length obtained through numerical modeling, and a black solid line is a correlation length obtained through theoretical prediction. (a) Sound source depth is 50 m; (b) sound source depth is 100 m; (c) sound source depth is 150 m; and (d) sound source depth is 200 m. It can be seen that the theoretical calculation result given by the present invention is consistent with the numerical modeling result, thereby indicating the correctness of the theoretical calculation formula.

What is claimed is:

1. A method for obtaining horizontal longitudinal correlation of a deep-sea great-depth sound field, comprising the following steps:
step 1: determining two receiving positions with the same depth and different distances from a deep sound source near a deep-sea bottom as testing positions, wherein coordinates of the two receiving positions are respectively (z,r) and (z,r+Δr); z indicates a receiving depth; r indicates a receiving distance; Δr indicates a horizontal longitudinal spacing of the two receiving positions; the depth wideband deep sound source is indicated by zₛ and a center frequency is indicated by ω₀;
step 2: calculating a time delay difference Δtᵣ between a direct wave of a wideband deep sound source reaching the receiving position (z,r) and a surface-reflected wave according to a ray model Bellhop, and calculating a time delay difference Δt_{r+Δr} between a direct wave of the wideband deep sound source reaching the receiving position (z,r+Δr) and the surface-reflected wave according to the ray model Bellhop; and
step 3: substituting the time delay differences Δtᵣ and Δt_{r+Δr} into a calculation formula of horizontal longitudinal correlation of the sound field,
$$p ( r , r + Δ r ) = cos ( \frac{{ω}_{0}}{2} ( Δ {t}_{r} - Δ {t}_{r} + {Δ}_{r} ) )$$
to obtain a horizontal longitudinal correlation coefficient of the sound field between two different receiving distances r and r+Δr when the depth of the sound source is zₛ and the receiving depth is z.

2. The method for obtaining the horizontal longitudinal correlation of the deep-sea great-depth sound field according to claim 1, wherein one testing position is fixed; the distance of the other testing position is changed along a horizontal direction, so that a horizontal longitudinal spacing Δr of the two receiving positions is changed; and then step 2 and step 3 are repeated to obtain a change rule of the correlation of the sound field along with the horizontal longitudinal spacing when a reference receiving distance is r.

3. The method for obtaining the horizontal longitudinal correlation of the deep-sea great-depth sound field according to claim 1, wherein the reference receiving distance r is changed, and then step 2 and step 3 are repeated to obtain the change rule of the correlation of the sound field at different receiving distances.

4. The method for obtaining the horizontal longitudinal correlation of the deep-sea great-depth sound field according to claim 1, wherein a change range of the sound source depth of the wideband deep sound source is 10-1000 m.

5. The method for obtaining the horizontal longitudinal correlation of the deep-sea great-depth sound field according to claim 1, wherein a frequency range of the wideband deep sound source is 10 Hz-5 kHz.

6. The method for obtaining the horizontal longitudinal correlation of the deep-sea great-depth sound field according to claim 1, wherein a receiving distance from the deep sound source to the receiving position is 0-30 km, and the receiving depth is in a range of 1000-10000 m.
